(19) United States
(12) Patent Application Publication
(10) Pub. No.: US 2007/0097681 A1
(43) Pub. Date: May 3, 2007

(54) Lighting device

(76) Inventors: Robert H. Chich, Mequon, WI (US); Chun-Ming Chen, Yung-Kung City (TW)

Correspondence Address: PRO-TECHTOR INTERNATIONAL SERVICES, 20775 NORADA CT., SARATOGA, CA, 95070, US

(21) Appl. No.: 11/265,066

(22) Filed: Nov. 1, 2005

(51) Int. Cl. B60Q 1/26

(52) U.S. Cl. 362/232; 362/555; 362/253; 362/479; 362/542; 362/545

(57) ABSTRACT

A lighting device is disclosed to include a light source formed of light emitting diodes and/or laser diodes and controlled to emit light and/or to flash by a programmable controller, a lens, which has raised portions for refracting the light of the light emitting diodes and/or laser diodes to produce a lighting effect, and a driving mechanism for rotating the lens relative to the light source.

### BACKGROUND OF THE INVENTION

1. Field of the Invention

The present invention relates to lamps and more particularly, to a lighting device that uses a lens with raised portions to refract the light of LEDs and/or laser diodes and a driving mechanism to rotate the lens relative to the LEDs and/or laser diodes, thereby producing a lighting effect.

2. Description of the Related Art

Following fast development of high technology, semiconductor light emitting devices, for example, LEDs (light emitting diodes) have been intensively used in signal lights, neon lights, light boxes, vehicle lamps, hand lamps, etc. to substitute for conventional incandescent and/or fluorescent bulbs for the advantages of low power consumption and low heat. Further, laser diodes are also intensively used in pointers, examination instruments, advertising apparatus. Further, when a laser light source is used to produce images of laser light, expensive peripheral apparatus (such as stepper motors and computer control systems) are needed to drive the laser light source.

There are commercial static electricity balls (plasma balls) and LAVA lamps commonly used in entertainment places, concerts, product exhibitions, etc. to attract customers and to create an exciting atmosphere. However, due to monotonous lighting effects and a long presence in market, these plasma balls and LAVA lamps cannot effectively attract people's attention.

### SUMMARY OF THE INVENTION

The present invention has been accomplished under the circumstances in view. It is therefore the main object of the present invention to provide lighting device, which produces a variable lighting effect that attracts people's attention. It is another object of the present invention to provide a lighting device, which is practical for use at home as well as in a concert, product exhibition, or the like for commercial purposes. To achieve these and other objects of the present invention, the lighting device comprises a light source, which comprises a circuit board, a plurality of light emitting devices installed in the circuit board, and a programmable controller electrically connected to the circuit board and adapted to control on/off and flashing of the light emitting device subject to a predetermined program, a lens, which is set in the path of the light emitted from the light emitting devices and has a plurality of raised portions for refracting the light emitted from the light emitting devices, and a driving device adapted to cause a relative rotary motion between the lens and the light source.

The light emitting devices can be light emitting diodes and/or laser diodes in one single color or different colors.

In one embodiment of the present invention, the driving device is adapted to rotate the lens relative to the light source. In another embodiment of the present invention, the driving mechanism is adapted to rotate the light source relative to the lens. Further, the raised portions of the lens may be made in different sizes and shapes, and arranged in an array or irregularly distributed over the surface of the lens. The lens can also have many different geometric shapes as well as being a flat shape with raised portions for refracting the light depending on the shape of the enclosure and the lighting effect that is being produced. And the programmable controller can also control the rotation of the driving device causing it to start and stop periodically depending on how the lighting effect has been programmed.

### BRIEF DESCRIPTION OF THE DRAWINGS

FIG. 1 is an exploded view of a lighting device according to a first embodiment of the present invention.

FIG. 2 is a schematic sectional plain view of the first embodiment of the present invention, showing the lighting device in operation.

FIG. 3 is a schematic sectional plain view, showing a lighting device in operation according to a second embodiment of the present invention.

FIG. 4 is a schematic sectional plain view, showing a lighting device in operation according to a third embodiment of the present invention.

FIG. 5 is a schematic sectional plain view, showing a lighting device in operation according to a fourth embodiment of the present invention.

FIG. 6 illustrates an irregular arrangement of the raised portions of the lens according to the present invention.

FIG. 7 is a schematic sectional plain view, showing a lighting device in operation according to a fifth embodiment of the present invention.

FIG. 8 is a schematic drawing showing the lighting device used with a planar display screen according to the present invention.

FIG. 9 is a schematic drawing showing the lighting device used with a bulb-like display screen according to the present invention.

### DETAILED DESCRIPTION OF THE PREFERRED EMBODIMENT

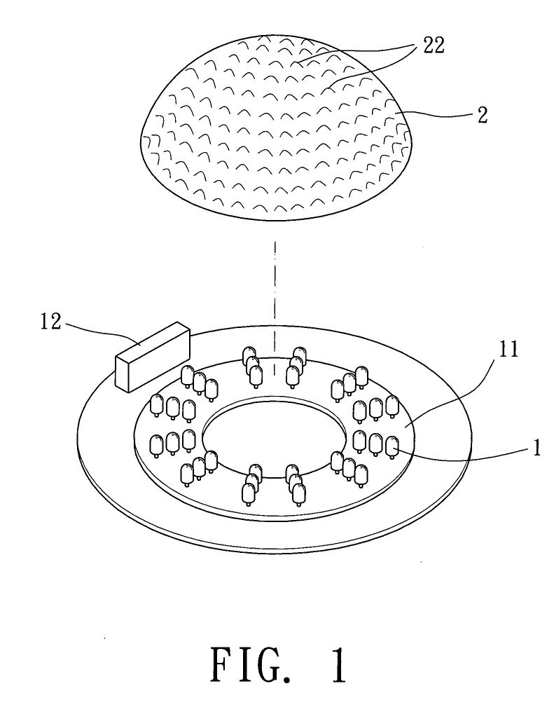

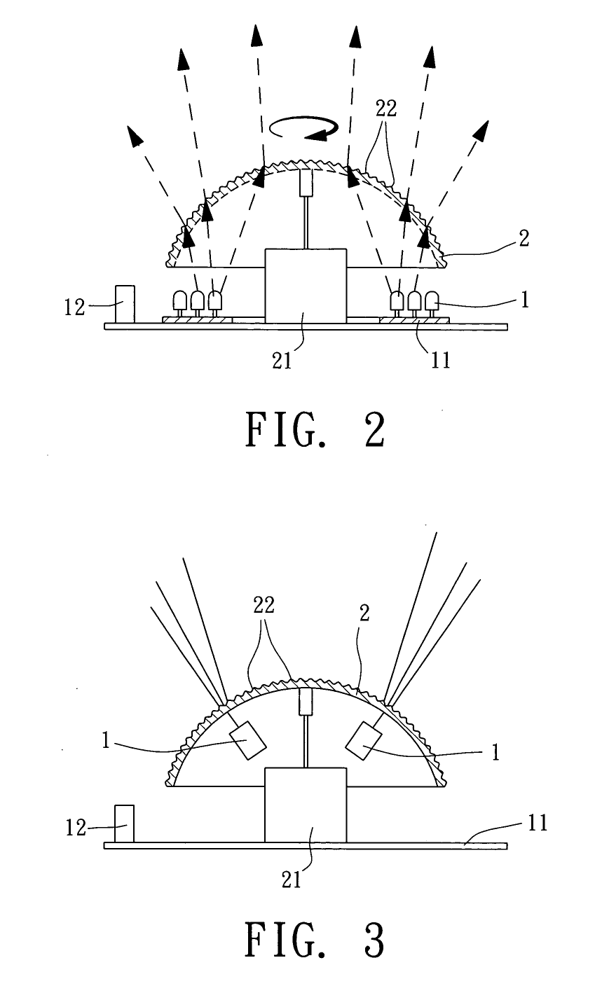

Referring to FIGS. 1 and 2, a lighting device in accordance with the present invention is shown comprised of a light source and a lens 2.

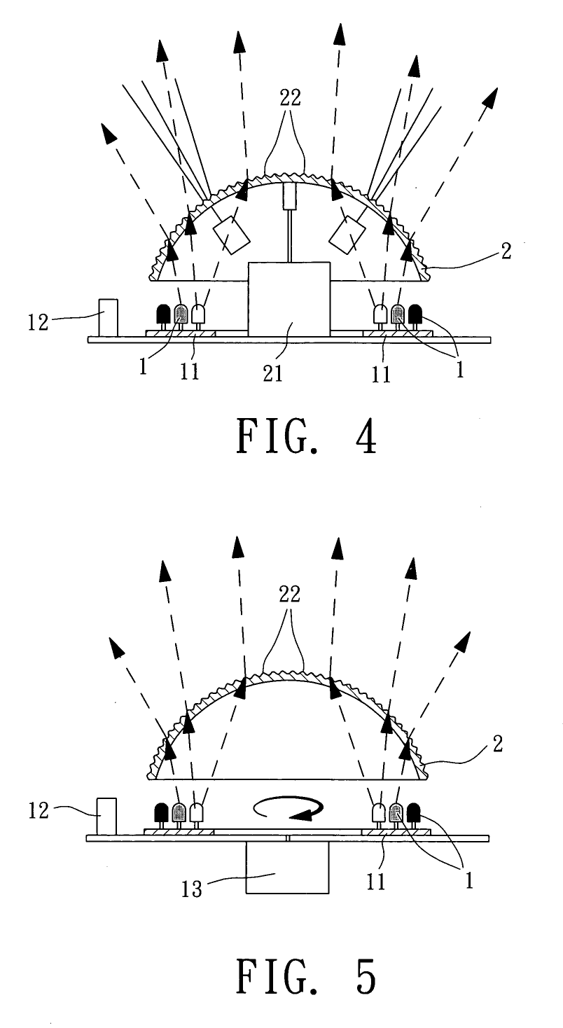

The light source comprises a circuit board 11, a plurality of light emitting devices 1 installed in the circuit board 11, and a programmable controller 12 adapted to control the operation (on/off and/or flashing) of the light emitting devices 11 subject to a predetermined program. The light emitting devices 1 can be regular LEDs (light emitting diodes), laser diodes (see FIG. 3), or a combination of LEDs and laser diodes (see FIG. 4). The light emitting devices 1 can be of the same color (see FIGS. 1 and 2). Alternatively, if the light emitting devices 1 are light emitting diodes, they can be made with different colors (see FIGS. 4 and 5). The color combination may include red, green and blue colors. Other color combinations (such as the combination of yellow, white and purple colors) are also possible.

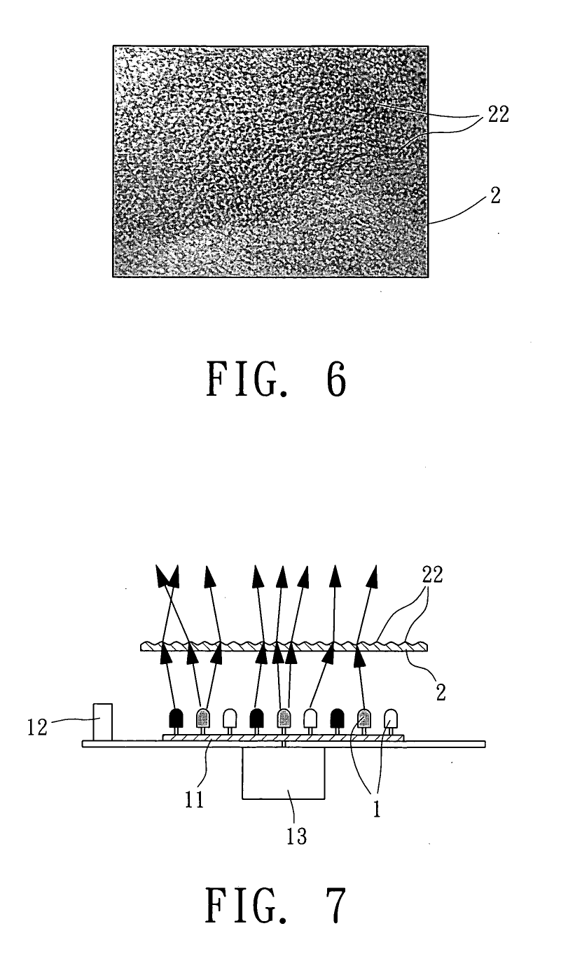

The lens 2 is set in the way of the light emitted from the light emitting devices 1, having a plurality of raised portions 22 protruding from the outer surface thereof for refracting the light from the light emitting devices 1 in different directions. The raised portions 22 may be made in different shapes and sizes and arranged in an array as shown in FIG. 1, or irregularly distributed over the surface of the lens 2 as shown in FIG. 6. Further, the lens 2 can be semispherical lens as shown in FIGS. 1˜5, or a flat panel lens 2 as shown in FIG. 7 or another geometric shape. Further, a driving device 21 is installed in the circuit board 11, and controlled to rotate the lens 2 relative to the light source (the light emitting devices 1) as shown in FIGS. 2˜4. Alternatively, a driving device 13 may be provided for rotating the light source (the light emitting devices 1) relative to the lens 2 as shown in FIGS. 5 and 7. The driving device 13 or 21 can be a motor or clock mechanism.

Further, the programmable controller 12 can also control the rotation of the driving device 13 or 21 causing it to start and stop periodically depending on how the lighting effect has been programmed. This feature adds another layer of entertainment value to the lighting effect.

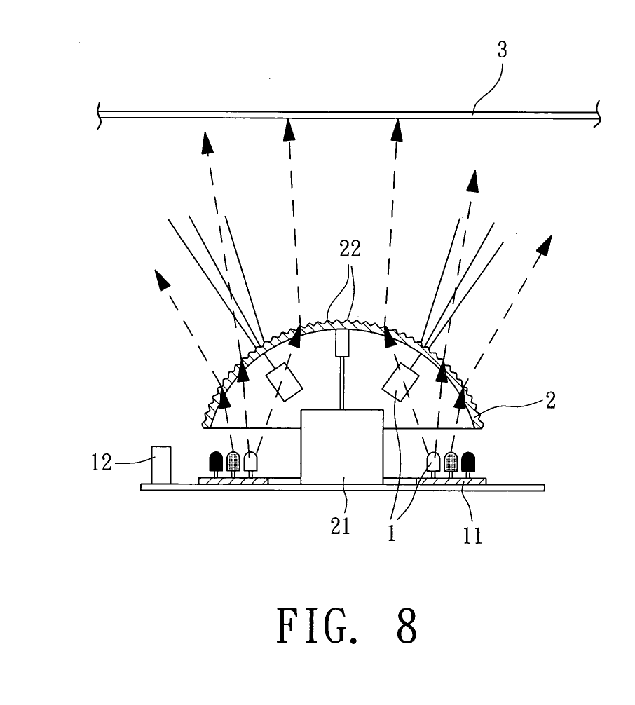

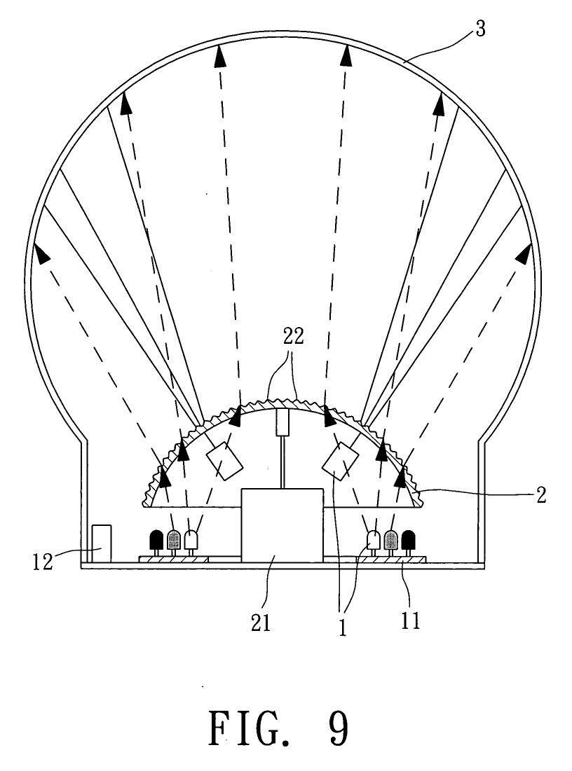

When electric current is connected to the lighting device, the programmable controller 12 controls on/off and/or flashing of the light emitting devices 1, and at the same time the raised portions 22 of the lens 2 refracts the light of the light emitting devices 1 onto a display screen 3 at different angles, thereby producing a lighting effect. The display screen 3 can be a flat wall surface or fabric screen (see FIG. 8), or a hollow shell shaped like a bulb (see FIG. 9) or other geometric shape like a cube or cylinder or free formed shape. During the operation of the light emitting devices 1, the driving device 13 or 21 is operated to rotate the circuit board 11 (light source) relative to the lens 2 or the lens 2 relative to the circuit board 11 (light source), causing a variety of the lighting effect. The visual effect can create dynamic, unique, intricate image (such as the appearance of a star galaxy or nebula type image). Therefore, the lighting device can be used in a home party to produce a fantastic, mysterious and dreamlike atmosphere. The light device can also be used in an entertainment place, concert, product conference, exhibition, etc.

As indicated above, the present invention provides a lighting device that uses LEDs and/or laser diodes to emit light, a lens with raised portions to refract the light of the LEDs and/or laser diodes in different directions, and a driving device to cause a relative rotary motion between the light source (LEDs and/or laser diodes) and the lens, thereby producing a variable lighting effect.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A lighting device comprising:
a light source, said light source comprising a circuit board, a plurality of light emitting devices installed in said circuit board, and a programmable controller electrically connected to said circuit board and adapted to control on/off and flashing of said light emitting device subject to a predetermined program;
a lens set in the path of the light emitted from said light emitting devices, said lens comprising a plurality of raised portions adapted to refract the light emitted from said light emitting devices; and
a driving means adapted to rotate one of said light source and said lens relative to the other of said light source and said lens.

2. The lighting device as claimed in claim 1, wherein said light emitting devices are laser diodes.

3. The lighting device as claimed in claim 1, wherein said light emitting devices are light emitting diodes.

4. The lighting device as claimed in claim 1, wherein said light emitting devices include light emitting diodes and laser diodes.

5. The lighting device as claimed in claim 1, wherein said light emitting devices have the same color.

6. The lighting device as claimed in claim 1, wherein said light emitting devices have different colors.

7. The lighting device as claimed in claim 1, wherein said driving means drives said light source to rotate relative to said lens.

8. The lighting device as claimed in claim 1, wherein said driving means drives said lens to rotate relative to said light source.

9. The lighting device as claimed in claim 1, wherein said raised portions of said lens protrude from an outer surface of said lens.

10. The lighting device as claimed in claim 9, wherein said raised portions have different shapes and sizes.

11. The lighting device as claimed in claim 9, wherein said raised portions are arranged in an array.

12. The lighting device as claimed in claim 9, wherein said raised portions are not aligned in line.

13. The lighting device as claimed in claim 1, wherein said lens is a flat lens.

14. The lighting device as claimed in claim 1, wherein said lens has an arched shape.

15. The lighting device as claimed in claim 1, wherein said the programmable controller can also control the rotation of the driving means causing it to start and stop periodically.
